(19) United States
(12) Patent Application Publication
(10) Pub. No.: US 2026/0169256 A1
(43) Pub. Date: Jun. 18, 2026

(54) MOUNT, ADAPTER RING, LENS, AND IMAGE CAPTURING DEVICE

(71) Applicant: SHENZHEN VILTROX TECHNOLOGY CO., LTD., SHENZHEN (CN)

(72) Inventors: Ruijun LIU, Shenzhen (CN); Baofeng CHEN, Shenzhen (CN)

(21) Appl. No.: 19/531,630

(22) Filed: Feb. 5, 2026

(30) Foreign Application Priority Data
Nov. 13, 2025 (CN) 2025116621310

(51) Int. Cl. G02B 7/14

(52) U.S. Cl. CPC G02B 7/14

(57) ABSTRACT

A mount, an adapter ring, a lens, and an image capturing device are provided. The mount includes a mount body, a mounting member configured to connect the mount body to the lens, a fixed protruding portion, and a movable protruding portion connected to the mount body. When the mount is rotationally engaged with a camera body, the movable protruding portion swings about an intermediate position in a direction away from an optical axis and engages with the camera body. The adapter ring includes an adapter ring body and the mount. The lens includes a lens body and the mount. The image capturing device includes a camera body and the lens. Through cooperation between the fixed protruding portion and the movable protruding portion, collision and jamming during mounting are reduced while reliable assembly is ensured, thereby improving user experience.

### TECHNICAL FIELD

The present disclosure relates to the field of photographic technology, and more particularly to a mount, an adapter ring, a lens, and an image capturing device.

### BACKGROUND

With the continuous development of society and economy, as material living standards improve, people's demand for spiritual culture and entertainment experiences continues to increase, driving a growing number of consumers to engage in photography. Photography enthusiasts and other user groups have raised higher requirements for performance, operational experience, and structural details of cameras and related imaging equipment.

Currently, mainstream cameras generally include a camera body and a lens. To facilitate portability and storage, the camera body is provided with a dedicated camera mount having a plurality of camera claws, while the lens is provided with a corresponding mount having mating claws or protruding structures. The lens and the camera body are detachably connected through engagement between the claws or protrusions.

However, during mounting and dismounting, existing lens mount structures often suffer from collision or jamming due to inaccurate alignment of the claws or suboptimal structural design, resulting in unsmooth assembly or disassembly and adversely affecting operational smoothness and overall user experience.

### SUMMARY

An objective of embodiments of the present disclosure is to provide a mount, an adapter ring, a lens, and an image capturing device, so as to address technical problems in the prior art in which collisions and jamming are prone to occur between a lens mount and camera claws during mounting of a lens to a camera body.

To achieve the above objective, the present disclosure adopts the following technical solutions.

According to a first aspect, a mount is provided for detachably connecting a lens to a camera body. The mount includes:
a mount body;
a mounting member connected to the mount body and configured to connect the mount body to the lens;
a fixed protruding portion connected to the mount body; and
a movable protruding portion connected to the mount body,
wherein, when the movable protruding portion is rotated and engaged with the camera body, the movable protruding portion swings about an intermediate position in a direction away from an optical axis and engages with the camera body.

Optionally, the movable protruding portion includes a first protruding portion and a second protruding portion having equal dimensions in a length direction, the first protruding portion being closer to the optical axis than the second protruding portion in an initial state. During engagement with the camera body, the first protruding portion moves in a direction away from the optical axis and protrudes beyond an outer edge of the mount body.

Optionally, after engagement with the camera body, the first protruding portion moves away from the optical axis and becomes flush with the second protruding portion.

Optionally, at least one of the first protruding portion or the second protruding portion protrudes beyond an outer edge of the mount body in the initial state.

Optionally, at least one of the first protruding portion or the second protruding portion is closer to the optical axis than the fixed protruding portion in the initial state.

Optionally, after the movable protruding portion is disengaged from a triggered state relative to the mount body, the first protruding portion moves toward the optical axis.

Optionally, the movable protruding portion further includes a rotating portion connected to the first protruding portion and the second protruding portion, the rotating portion being rotatably connected to the mount body such that the first protruding portion and the second protruding portion are configured to swing about the rotating portion.

Optionally, the rotating portion is located at an intermediate position between the first protruding portion and the second protruding portion.

Optionally, during engagement with the camera body, the first protruding portion swings about the rotating portion in a direction away from the optical axis, and the second protruding portion swings about the rotating portion in a direction toward the optical axis.

Optionally, the movable protruding portion further includes a pressing portion configured to abut against the camera body and drive the movable protruding portion to move away from the optical axis, the pressing portion being connected to the second protruding portion.

Optionally, the pressing portion protrudes beyond an outer edge of the mount body in the initial state.

Optionally, the pressing portion is connected to a side of the second protruding portion facing away from the camera body.

Optionally, the mount further includes a restoring member connected to the mount body and the movable protruding portion, the restoring member being configured to restore the movable protruding portion to the initial state.

Optionally, one end of the restoring member abuts against the movable protruding portion and is compressed when the movable protruding portion is engaged with the camera body, such that the restoring member stores elastic energy.

Optionally, the restoring member is an elastic plate attached to the mount body, and one end of the elastic plate abuts against a side of the first protruding portion facing away from the optical axis, or abuts against a side of the second protruding portion facing toward the optical axis.

Optionally, an angle formed between lines connecting both ends of the fixed protruding portion in a length direction and the optical axis is equal to an angle formed between lines connecting both ends of the movable protruding portion in the length direction in at least one of an initial state or a swung state.

Optionally, the angle formed between lines connecting both ends of the fixed protruding portion in the length direction and the optical axis is greater than or equal to 42°, and the angle formed between lines connecting both ends of the movable protruding portion in the length direction and the optical axis is greater than or equal to 42°.

Optionally, the movable protruding portion includes a limiting protrusion configured to abut against the mount body to limit a movement range of the movable protruding portion.

Compared with the prior art, the mount provided herein reduces collision during mounting while ensuring reliable engagement, thereby improving assembly smoothness and user experience.

According to a second aspect, an adapter ring is provided, including an adapter ring body and the mount described above, wherein the mount is connected to the adapter ring body.

The adapter ring enables lenses of different mount standards to be connected to a camera body while reducing collision and jamming during mounting.

According to a third aspect, a lens is provided, including a lens body and the mount described above, wherein the mount is connected to the lens body.

The lens benefits from reduced collision and smoother mounting through the movable protruding portion of the mount.

According to a fourth aspect, an image capturing device is provided, including a camera body having a camera mount and the lens described above, wherein the lens is connected to the camera mount of the camera body through the mount.

The image capturing device achieves improved mounting smoothness and enhanced user experience.

### BRIEF DESCRIPTION OF DRAWINGS

To more clearly describe the technical solutions of embodiments of the present disclosure, the drawings required in the embodiments or the prior art are briefly described below. It should be understood that the drawings described below are merely some embodiments of the present disclosure, and other drawings may be obtained by those skilled in the art without creative effort.

FIG. 1 is a schematic diagram showing a first perspective structural view of a mount according to an embodiment of the present disclosure.

FIG. 2 is a schematic diagram showing an exploded structural view of the mount according to an embodiment of the present disclosure.

FIG. 3 is a schematic diagram showing a second perspective structural view of the mount according to an embodiment of the present disclosure.

FIG. 4 is a schematic diagram showing a top view of the mount according to an embodiment of the present disclosure in an initial state.

FIG. 5 is a schematic diagram showing a top view of the mount according to an embodiment of the present disclosure in a triggered state.

FIG. 6 is a schematic diagram showing alignment between the mount and a camera mount according to an embodiment of the present disclosure.

FIG. 7 is a schematic diagram showing a cooperative structural state between the mount and the camera mount according to an embodiment of the present disclosure in an initial state.

FIG. 8 is a schematic diagram showing an enlarged partial view of region A in FIG. 7.

FIG. 9 is a schematic diagram showing a cooperative structural state between the mount and the camera mount according to an embodiment of the present disclosure in a triggered state.

FIG. 10 is a schematic diagram showing a top view of a cooperative state between the mount and the camera mount according to an embodiment of the present disclosure in an initial state.

FIG. 11 is a schematic diagram showing a top view of a cooperative state between the mount and the camera mount according to an embodiment of the present disclosure in a triggered state.

FIG. 12 is a schematic diagram showing a first perspective structural view of a movable protruding portion adopted in an embodiment of the present disclosure.

FIG. 13 is a schematic diagram showing a second perspective structural view of the movable protruding portion adopted in an embodiment of the present disclosure.

FIG. 14 is a schematic diagram showing a perspective structural view of a lens according to an embodiment of the present disclosure.

FIG. 15 is a schematic diagram showing a perspective structural view of a camera according to an embodiment of the present disclosure.

FIG. 16 is a schematic diagram showing an exploded structural view of a camera according to an embodiment of the present disclosure.

### DETAILED DESCRIPTION OF EMBODIMENTS

In order to make the technical problems to be solved, the technical solutions, and the beneficial effects of the present disclosure more clearly understood, the present disclosure is further described in detail below with reference to the accompanying drawings and embodiments. It should be understood that the specific embodiments described herein are merely for explaining the present disclosure and are not intended to limit the present disclosure.

It should be noted that when an element is described as being “fixed to” or “disposed on” another element, the element may be directly fixed to or disposed on the other element, or may be indirectly fixed to or disposed on the other element. When an element is described as being “connected to” another element, the element may be directly connected to the other element or indirectly connected thereto.

It should be further understood that terms such as “length,” “width,” “upper,” “lower,” “front,” “rear,” “left,” “right,” “vertical,” “horizontal,” “top,” “bottom,” “inner,” and “outer” indicate orientations or positional relationships based on those shown in the drawings and are used only for convenience of description and to simplify the description, rather than indicating or implying that the device or element must have a particular orientation or be constructed and operated in a particular orientation.

In addition, the terms “first” and “second” are used merely for descriptive purposes and are not to be construed as indicating or implying relative importance or implicitly specifying the number of the indicated technical features. Thus, features defined with “first” or “second” may explicitly or implicitly include one or more such features. In the description of the present disclosure, the term “a plurality of” means two or more, unless otherwise specifically defined.

Technical features described in different embodiments may be combined in any suitable manner without conflict. To avoid unnecessary repetition, various possible combinations are not described again herein.

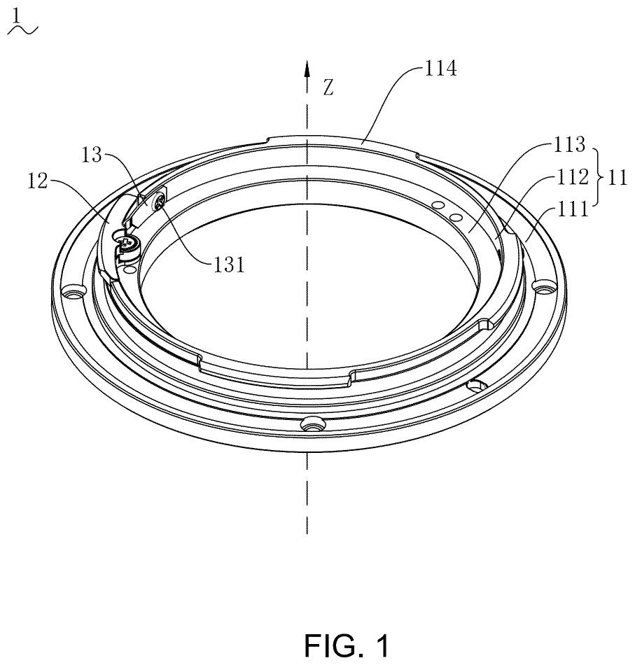

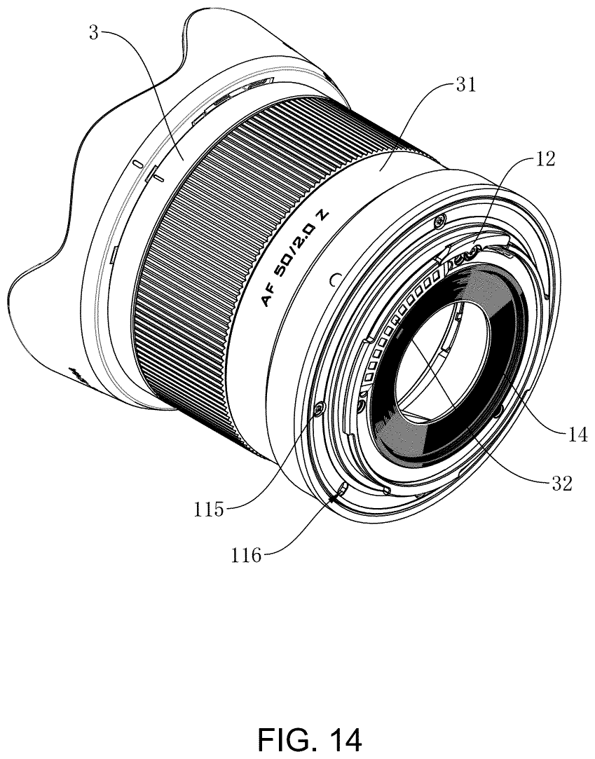

Referring to FIG. 1 and FIG. 14, a mount 1 according to an embodiment of the present disclosure may be installed as a component in a lens (as shown in FIG. 14), or may be installed as a component in an adapter ring. The adapter ring enables a lens having one mount standard to be installed on a camera body 2 having another mount standard.

For ease of description, the present embodiment is described with the mount 1 being installed in a lens as an example. However, this is not intended to limit the present disclosure, and the mount 1 may also be applied to an adapter ring or other devices.

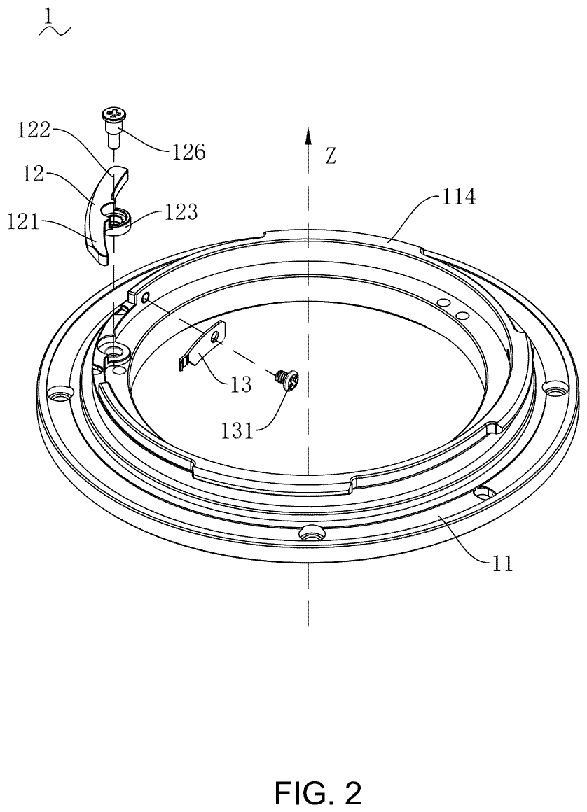

Referring to FIGS. 1 to 3, the mount 1 includes a mount body 11, a mounting member 115, a movable protruding portion 12, and a fixed protruding portion 114.

The mounting member 115 is connected to the mount body 11 and is configured to mount the mount body 11 to a lens body 3. The movable protruding portion 12 and the fixed protruding portion 114 are connected to the mount body 11. The movable protruding portion 12 is configured to swing about an intermediate position in a direction away from an optical axis (i.e., the Z-axis shown in the drawings).

When a lens provided with the mount 1 is engaged with a camera body 2, the camera body 2 is provided with a camera mount 21 including camera claws 211. The movable protruding portion 12 is aligned with a corresponding mounting notch 212 in the camera mount 21.

Since the movable protruding portion 12 is not yet triggered by the camera body 2 and remains in an initial state, direct collision with the camera mount 21 is avoided, thereby improving smoothness and tactile feedback during mounting.

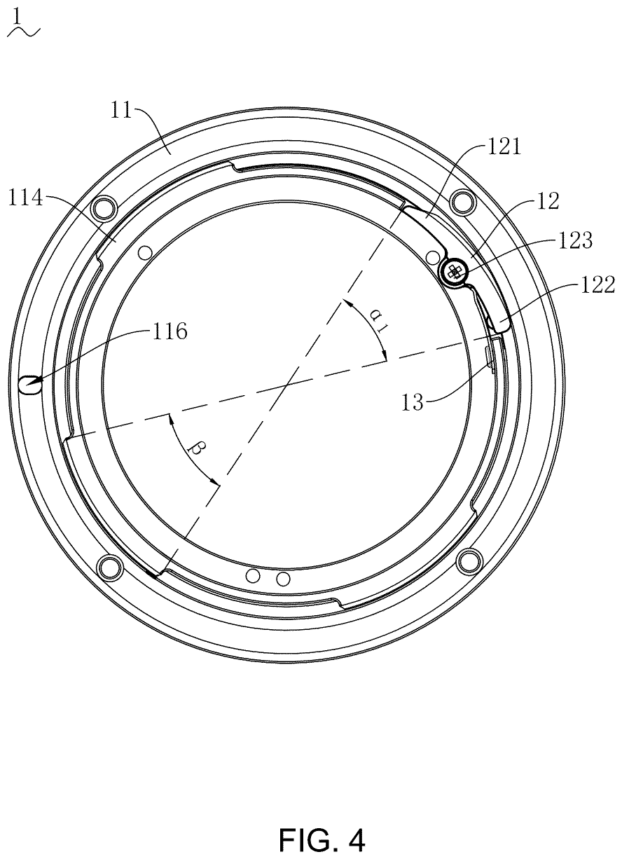

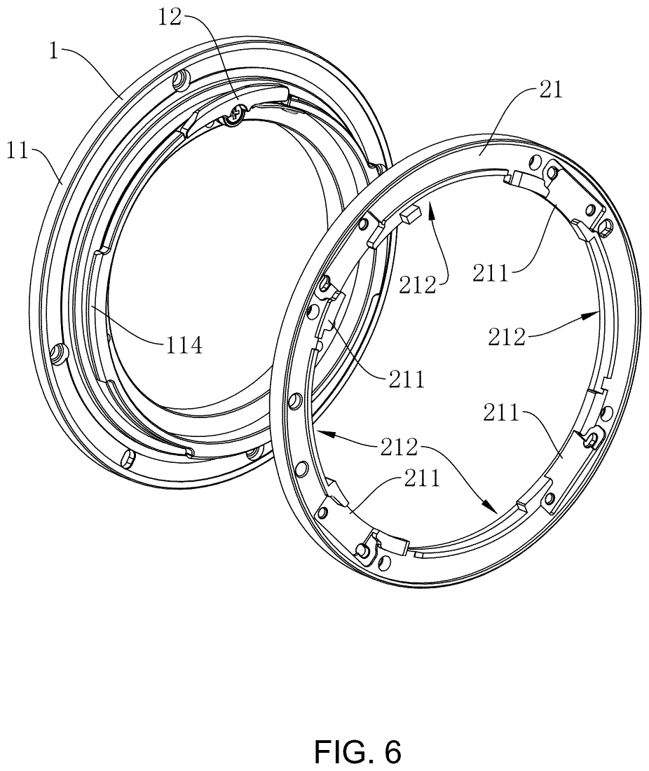

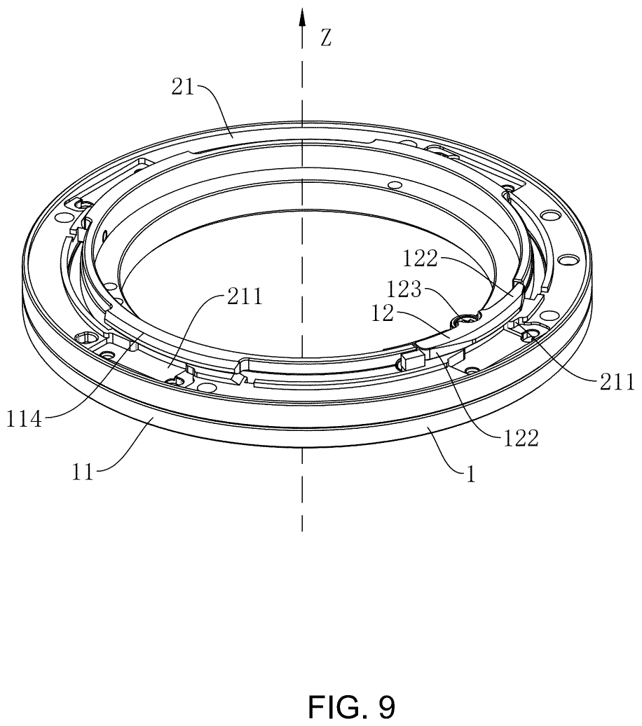

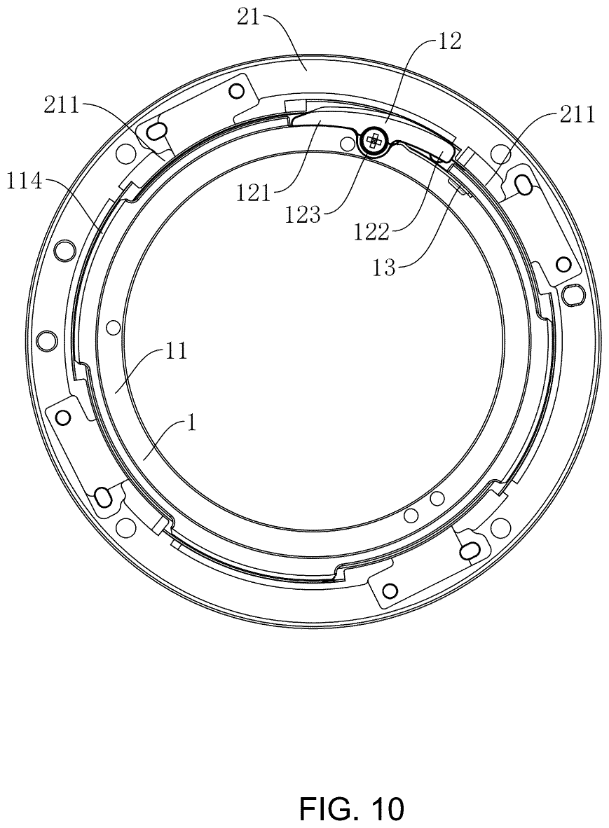

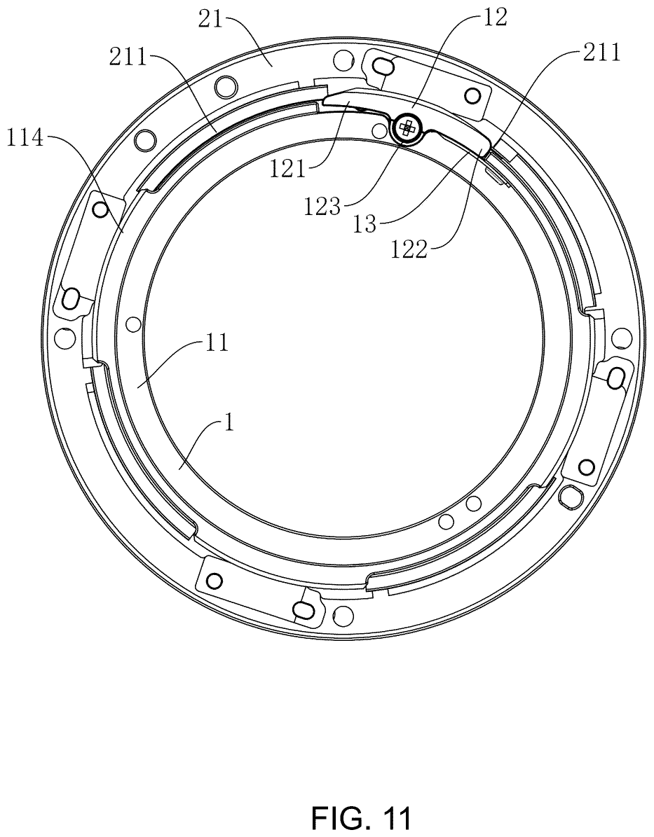

Referring to FIGS. 4 to 11, after the lens is engaged with the camera body 2 and rotated, the camera mount 21 of the camera body 2 contacts the movable protruding portion 12. During rotation and engagement, a portion of the movable protruding portion 12 moves in a direction away from the optical axis, enabling the movable protruding portion 12 to engage with the camera mount 21 and securely mount the lens to the camera body 2.

Conversely, when the lens is removed by rotating it in an opposite direction, the camera body 2 disengages from the movable protruding portion 12. The movable protruding portion 12 then returns to the initial state and moves toward the optical axis, allowing the lens to be detached. During this process, the portion of the movable protruding portion 12 that is closer to the optical axis reduces collision with the camera claws 211.

Through this configuration, collision between the mount 1 and the camera body 2 is effectively reduced during mounting and dismounting, thereby improving smoothness and user experience.

By way of example, the mounting member 115 may be screws for the mount 1. A plurality of screw holes are formed in the mount body 11, and screws pass through the screw holes to connect the mount 1 to the lens.

In other embodiments, the mounting member 115 may alternatively be snap-fit structures, adhesive bonding, threaded structures, or other suitable connection mechanisms.

In one optional embodiment, the movable protruding portion 12 includes a first protruding portion 121 and a second protruding portion 122. In the initial state, the first protruding portion 121 is closer to the optical axis than the second protruding portion 122.

When the movable protruding portion 12 is rotated and engaged with the camera body 2, under the action of the camera body 2, the first protruding portion 121 moves in a direction away from the optical axis and protrudes beyond an outer edge of the mount body 11, thereby engaging with the camera claws 211 of the camera mount 21.

With this configuration, when the lens is aligned with the camera body 2, the first protruding portion 121, being closer to the optical axis, significantly reduces collision between the movable protruding portion 12 and the camera body 2, thereby improving mounting smoothness. During rotational engagement, the movable protruding portion 12 is triggered by the camera body 2 to move and engage with the camera claws 211, ensuring reliable mounting.

It should be noted that “the first protruding portion 121 being closer to the optical axis than the second protruding portion 122” means that at least one side surface of the first protruding portion 121 is closer to the optical axis than a corresponding side surface of the second protruding portion 122, and other interpretations consistent therewith are also encompassed.

In one optional embodiment, after engagement with the camera body 2, the first protruding portion 121 moves away from the optical axis and becomes substantially flush with the second protruding portion 122, such that both the first protruding portion 121 and the second protruding portion 122 engage with the camera mount 21, thereby ensuring reliable mounting of the lens.

In one optional embodiment, at least one of the first protruding portion 121 or the second protruding portion 122 protrudes beyond an outer edge of the mount body 11 in the initial state. This allows the movable protruding portion 12 to be designed more compactly relative to the mount body 11, reducing overall size and improving space utilization.

In practical applications, the first protruding portion 121 may slightly protrude beyond the outer edge of the mount body 11 to minimize collision, while the second protruding portion 122 may protrude further to achieve better spatial efficiency.

In one optional embodiment, at least one of the first protruding portion 121 or the second protruding portion 122 is closer to the optical axis than the fixed protruding portion 114 in the initial state. This configuration further reduces exposure of the movable protruding portion 12 beyond the outer edge of the mount body 11, thereby reducing collision with the camera mount 21.

In practical applications, the second protruding portion 122 may be substantially flush with the fixed protruding portion 114 in the initial state, or may protrude slightly beyond the mount body 11. After rotational engagement, the second protruding portion 122 may become flush with the first protruding portion 121 and the fixed protruding portion 114.

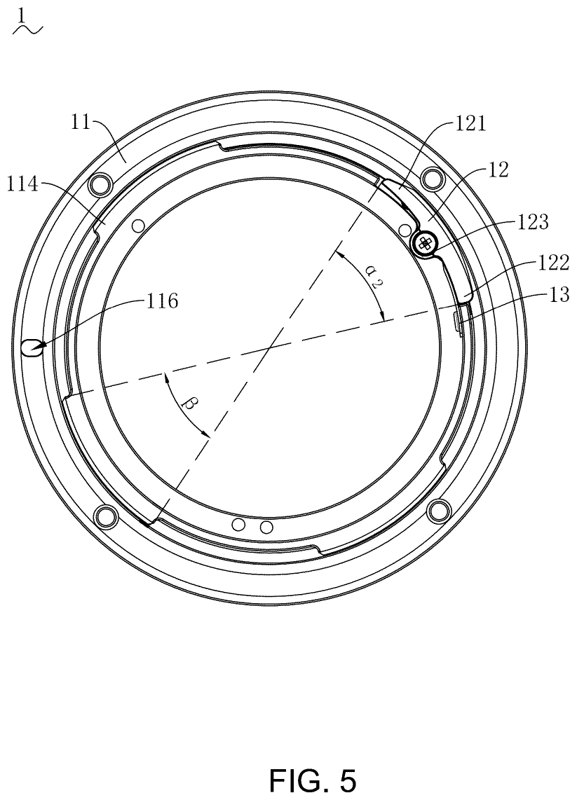

Referring to FIGS. 4 and 5, after the movable protruding portion 12 is disengaged from a triggered state relative to the mount body 11, the first protruding portion 121 moves toward the optical axis. During removal of the lens from the camera body 2, this movement reduces the area of the first protruding portion 121 protruding beyond the outer edge of the mount body 11, thereby reducing collision and improving user experience.

In one optional embodiment, a length of the first protruding portion 121 in a circumferential direction is equal to a length of the second protruding portion 122 in the circumferential direction. As a result, when the movable protruding portion 12 is engaged with the camera body 2, approximately half of the movable protruding portion 12 moves in a direction away from the optical axis.

It should be noted that the circumferential length refers to an arc length or a corresponding angular span along a circumferential direction of the mount body 11.

Referring to FIGS. 4, 12, and 13, in one optional embodiment, the movable protruding portion 12 further includes a rotating portion 123. The rotating portion 123 is connected to the first protruding portion 121 and the second protruding portion 122, and is rotatably connected to the mount body 11. During mounting and dismounting, the first protruding portion 121 and the second protruding portion 122 swing about the rotating portion 123.

This configuration allows the movable protruding portion 12 to move toward or away from the optical axis, thereby reducing collision with the camera mount 21 and enabling reliable engagement with the camera claws 211.

Referring to FIGS. 4 and 5, during engagement with the camera body 2, the first protruding portion 121 swings about the rotating portion 123 in a direction away from the optical axis, while the second protruding portion 122 swings about the rotating portion 123 in a direction toward the optical axis.

In one optional embodiment, the rotating portion 123 is located at an intermediate position between the first protruding portion 121 and the second protruding portion 122, such that the first protruding portion 121 and the second protruding portion 122 swing about the intermediate position.

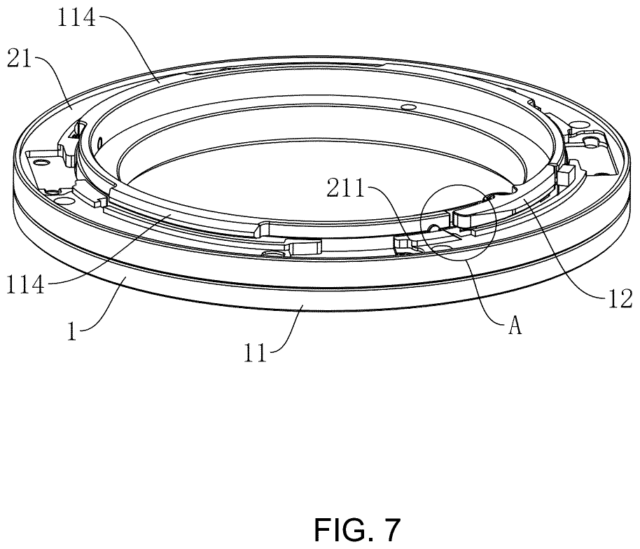

Referring to FIGS. 7, 8, 12, and 13, in one optional embodiment, the movable protruding portion 12 further includes a pressing portion 124 connected to the second protruding portion 122.

When the lens is aligned with and rotated relative to the camera body 2, the pressing portion 124 abuts against the camera body 2 and is pressed thereby, causing the movable protruding portion 12 to swing along a predetermined trajectory and engage with the camera mount 21.

In practical applications, under the interaction between the pressing portion 124 and the camera body 2, the first protruding portion 121 swings away from the optical axis while the second protruding portion 122 swings toward the optical axis.

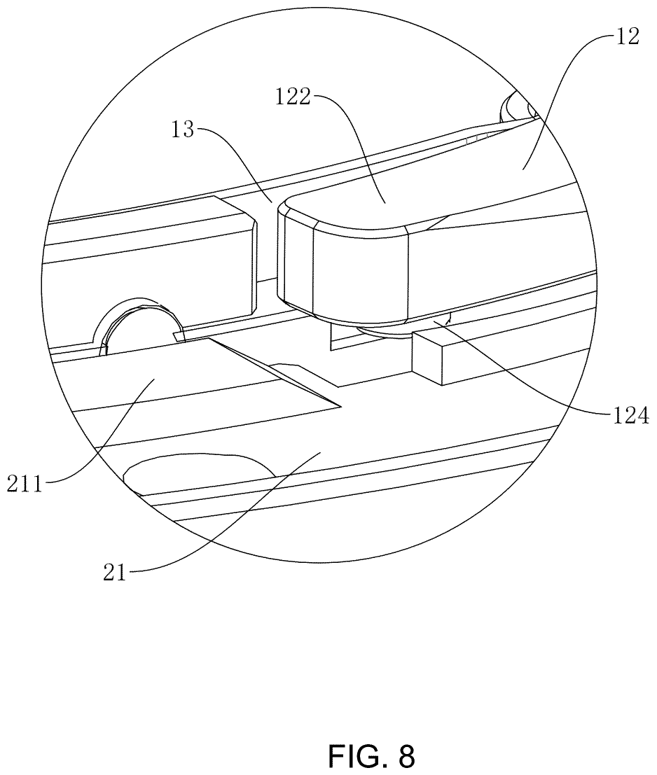

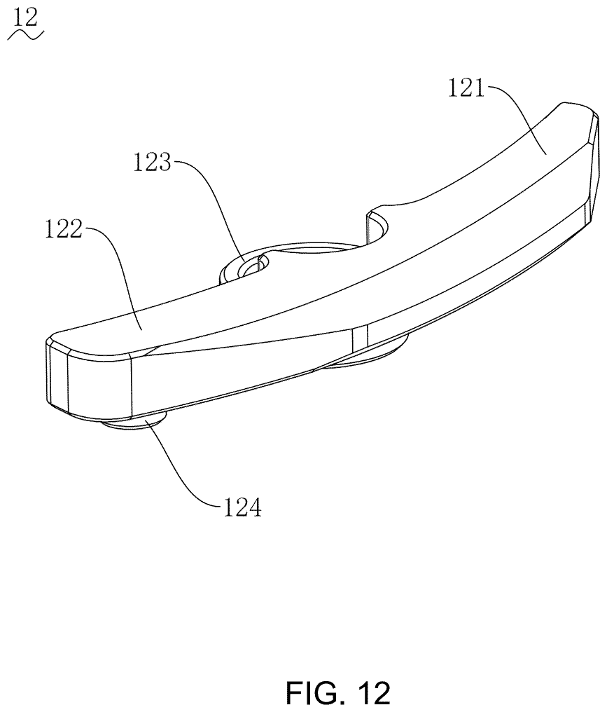

Referring to FIGS. 8 and 12, in one optional embodiment, the pressing portion 124 protrudes beyond an outer edge of the mount body 11 in the initial state. This allows the pressing portion 124 to contact the camera claws 211 at an early stage of rotation, thereby promptly driving movement of the movable protruding portion 12.

Referring to FIGS. 8, 12, and 13, in one optional embodiment, the pressing portion 124 is connected to a side of the second protruding portion 122 facing away from the camera body 2. In this configuration, during engagement, the pressing portion 124 is substantially coplanar with the camera claws 211, facilitating smooth contact and engagement.

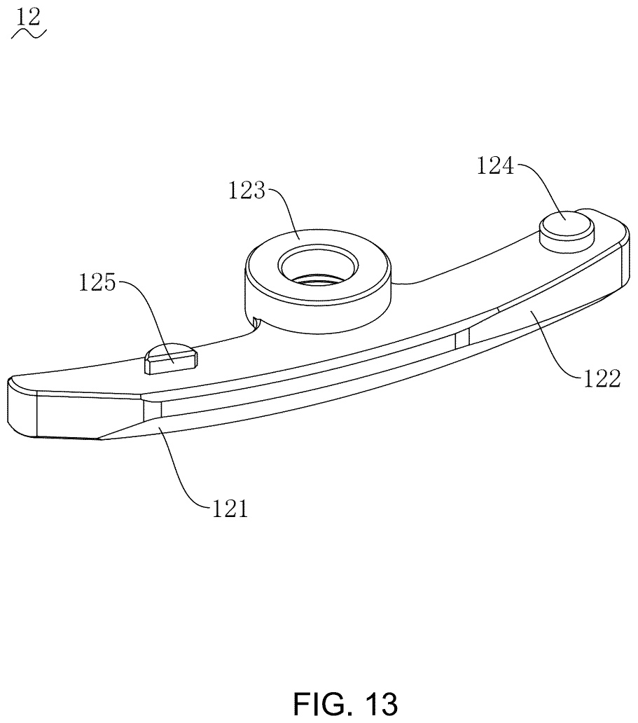

Referring to FIG. 13, in one optional embodiment, the movable protruding portion 12 includes a limiting protrusion 125 configured to abut against the mount body 11 to limit a range of movement of the movable protruding portion 12.

The limiting protrusion 125 may be connected to the first protruding portion 121 and positioned closer to the lens than the first protruding portion 121, such that when the first protruding portion 121 swings toward the optical axis beyond a predetermined distance, the limiting protrusion 125 contacts the mount body 11, preventing excessive movement and improving reliability.

In one optional embodiment, the movable protruding portion 12 is formed as a one-piece structure. The first protruding portion 121 and the second protruding portion 122 together form a main engagement portion of the movable protruding portion 12 that engages with the camera claws 211.

The first protruding portion 121 and the second protruding portion 122 include opposite bottom surfaces and top surfaces. The limiting protrusion 125 and the pressing portion 124 are disposed on the bottom surface. The pressing portion 124 may be cylindrical, facilitating smoother contact with the camera claws 211 and improving rotational tactile feedback.

Referring to FIGS. 12 and 13, the rotating portion 123 may be a cylindrical structure located closer to the second protruding portion 122 and the pressing portion 124. A through hole is formed in the rotating portion 123, and a fastener 126 passes through the through hole to rotatably connect the rotating portion 123 to the mount body 11.

The rotating portion 123 is positioned closer to the optical axis than the first protruding portion 121 and the second protruding portion 122, such that after assembly, the rotating portion 123 is located inside the mount body 11, thereby avoiding interference with engagement between the lens and the camera body 2.

Referring to FIGS. 4 and 5, in one optional embodiment, an angle β formed between lines connecting both ends of the fixed protruding portion 114 in a length direction and the optical axis is equal to an angle (α1 or α2) formed between lines connecting both ends of the movable protruding portion 12 in a length direction and the optical axis, in at least one of the initial state or a triggered state.

The equality of angles includes cases in which β=α1 and/or β=α2.

In one optional embodiment, the angle α1 formed in the initial state is equal to the angle α2 formed after swinging, such that the movable protruding portion 12 maintains a consistent angular relationship with respect to the optical axis before and after engagement.

Referring to FIGS. 4 and 5, in one optional embodiment, the angle β of the fixed protruding portion 114 is greater than or equal to 42°, and the angles α1 and α2 of the movable protruding portion 12 are also greater than or equal to 42°.

For example, the angle α may be 43°. In other embodiments, the angle may be 42°, 44°, 45°, or a non-integer angle such as 42.5°, 43.5°, 44.5°, or 45.5°.

Similarly, the angle β may be 43°, or may alternatively be 42°, 44°, 45°, or a non-integer angle.

In practical applications, the number and arrangement of fixed protruding portions 114 and movable protruding portions 12 may be adjusted according to the structure of the camera mount 21.

For example, when the camera mount 21 includes four camera claws 211, the mount 1 may include a total of four protruding portions, of which three are fixed protruding portions 114 and one is a movable protruding portion 12, or two are fixed protruding portions 114 and two are movable protruding portions 12, arranged alternately.

Referring to FIGS. 1 to 3, in one optional embodiment, the mount 1 further includes a restoring member 13 connected to the mount body 11 and the movable protruding portion 12.

When the lens is rotated in a reverse direction and removed from the camera body 2, the restoring member 13 applies a restoring force to the movable protruding portion 12, causing the movable protruding portion 12 to return to the initial state.

Referring to FIGS. 4 and 5, one end of the restoring member 13 abuts against the movable protruding portion 12. During engagement, the movable protruding portion 12 compresses the restoring member 13, causing the restoring member 13 to store elastic energy.

Referring to FIGS. 1 to 4, in one optional embodiment, the restoring member 13 is an elastic plate attached to the mount body 11. One end of the elastic plate abuts against a side of the second protruding portion 122 facing toward the optical axis.

During engagement, the second protruding portion 122 swings toward the optical axis and presses against the elastic plate, causing the elastic plate to store elastic energy. During dismounting, when the camera claws 211 no longer contact the pressing portion 124, the elastic plate releases stored energy and drives the movable protruding portion 12 to swing back, restoring the initial state.

This elastic plate configuration enables reliable restoration while maintaining a compact structure and simplified design.

In other embodiments, the elastic plate may be disposed on a side of the mount body 11 facing away from the optical axis, with its end abutting against a side of the first protruding portion 121 facing away from the optical axis, achieving a similar restoring effect.

In another optional embodiment, the restoring member 13 may be a torsion spring integrated into the through hole of the rotating portion 123. When the movable protruding portion 12 swings about the rotating portion 123, the torsion spring stores elastic energy and releases the energy during dismounting to restore the movable protruding portion 12.

Referring to FIGS. 1 to 3, in one optional embodiment, the mount body 11 includes a main body portion 111, a mount portion 112, and an installation portion 113.

The mount portion 112 is connected to the main body portion 111, and the installation portion 113 is connected to the mount portion 112. The main body portion 111 is configured to connect to the lens body 3, while the mount portion 112 and the installation portion 113 accommodate the restoring member 13 and the movable protruding portion 12. The mount portion 112 is configured to engage with the camera mount 21.

More specifically, the main body portion 111 and the installation portion 113 are annular structures, and the mount portion 112 is a cylindrical structure. The main body portion 111 is connected to an outer side of the mount portion 112 and near an end face thereof, and the installation portion 113 is connected to an inner side of the mount portion 112. The main body portion 111, the installation portion 113, and the mount portion 112 may be integrally formed.

Referring to FIG. 14, in one optional embodiment, the mount 1 further includes a decorative ring 14 connected to the mount portion 112 of the mount body 11.

The decorative ring 14 covers the restoring member 13 and includes a notch through which electrical contact pins 32 of the lens extend for electrical connection with the camera body 2.

Referring to FIG. 4, in one optional embodiment, a positioning groove 116 is formed in the main body portion 111 of the mount body 11 on a surface facing the camera body 2.

When the lens is mounted to the camera body 2, a positioning pin (not shown) of the camera body 2 extends into the positioning groove 116 to prevent unintended rotation of the lens.

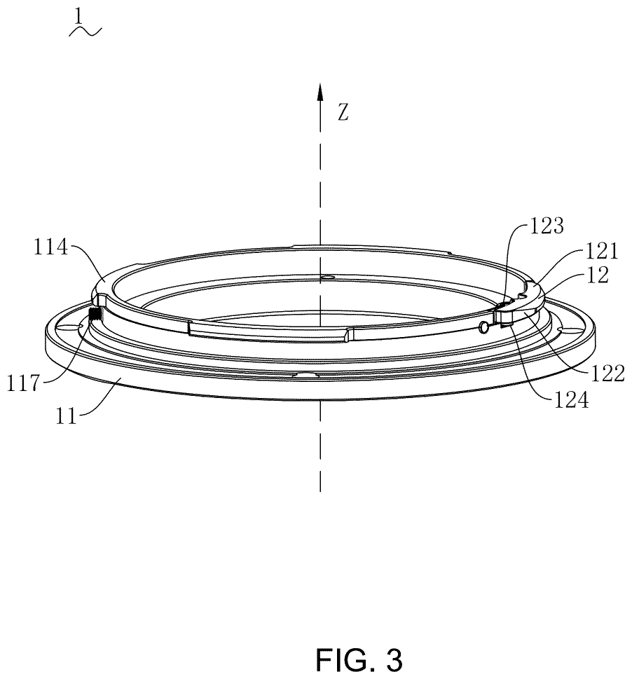

Referring to FIG. 3, in one optional embodiment, an anti-rotation screw 117 is disposed on an outer side surface of the mount portion 112 of the mount body 11.

During rotation of the lens, the anti-rotation screw 117 cooperates with the camera body 2 to limit rotation, thereby preventing excessive rotation and ensuring reliability.

When mounting the lens to the camera body 2, the movable protruding portion 12 and the fixed protruding portion 114 extend into corresponding notches of the camera body 2. During rotational engagement, a portion of the movable protruding portion 12 swings about its intermediate position and engages with the camera mount 21, ensuring reliable mounting.

During alignment, the movable protruding portion 12 remains in the initial state, reducing collision with the camera mount 21. After engagement, the movable protruding portion 12 moves away from the optical axis and engages with the camera body 2, reducing jamming while ensuring secure attachment and improving user experience.

The present disclosure further provides an adapter ring including an adapter ring body and the mount 1 described above, wherein the mount 1 is connected to the adapter ring body.

The adapter ring allows lenses of different mount standards to be mounted on a camera body 2. Through the movable protruding portion 12, collision during mounting is reduced, while reliable engagement is maintained.

Referring to FIG. 14, the present disclosure further provides a lens including a lens body 3 and the mount 1 described above, wherein the mount 1 is connected to the lens body 3.

The lens body 3 may include a frame, a mainboard, flexible cables, a lens group, and an exterior component 31. The exterior component 31 surrounds the frame, and a space is formed between the frame and the exterior component 31. The mainboard and flexible cables are disposed in the space. The frame is generally cylindrical, and the lens group is disposed in a cavity inside the frame. The mount 1 is connected to an end portion of the frame.

Through the movable protruding portion 12, collision during mounting is reduced and mounting smoothness is improved.

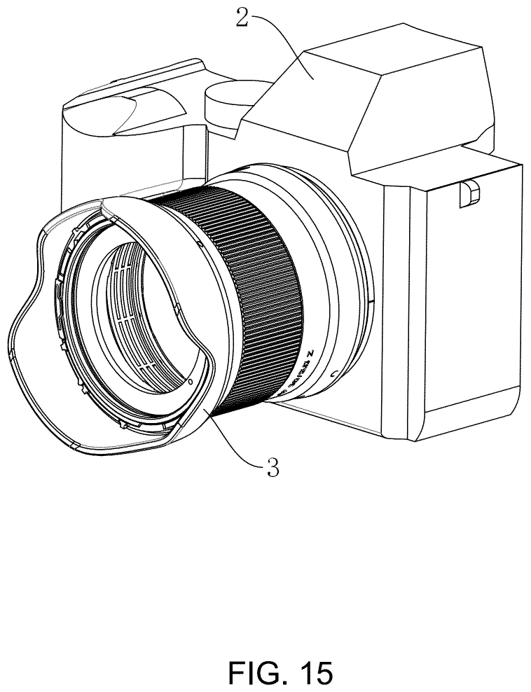

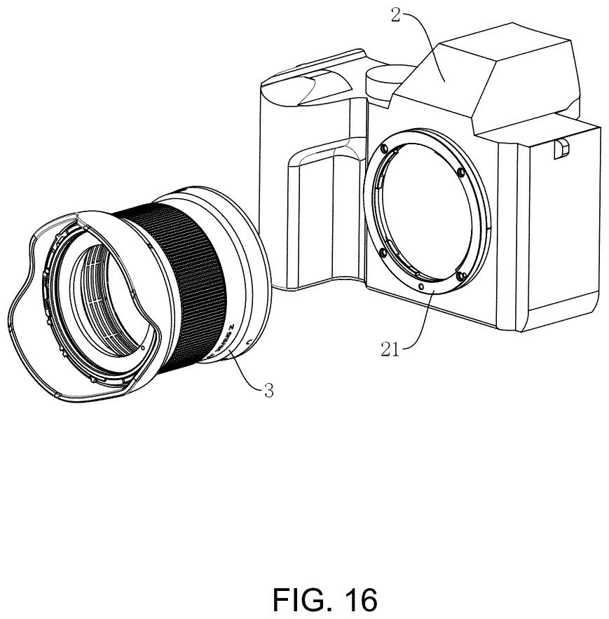

Referring to FIGS. 15 and 16, the present disclosure further provides an image capturing device including a camera body 2 having a camera mount 21 and the lens described above.

The lens is connected to the camera mount 21 of the camera body 2 through the mount 1.

The image capturing device reduces collision between the lens and the camera body 2, improves assembly smoothness, and enhances user experience.

The foregoing embodiments are merely preferred embodiments of the present disclosure and are not intended to limit the present disclosure. Any modifications, equivalent substitutions, or improvements made within the spirit and principles of The present disclosure shall fall within the scope of protection of The present disclosure.

1. A mount, configured to detachably connect a lens to a camera body, comprising:
a mount body;
a mounting member connected to the mount body and configured to connect the mount body to the lens;
a fixed protruding portion connected to the mount body; and
a movable protruding portion connected to the mount body,
wherein, when the movable protruding portion is rotated and engaged with the camera body, the movable protruding portion swings about an intermediate position in a direction away from an optical axis and engages with the camera body.

2. The mount according to claim 1, wherein the movable protruding portion comprises a first protruding portion and a second protruding portion, the first protruding portion being closer to the optical axis than the second protruding portion in an initial state, and wherein, during engagement with the camera body, the first protruding portion moves in a direction away from the optical axis and protrudes beyond an outer edge of the mount body.

3. The mount according to claim 2, wherein after engagement with the camera body, the first protruding portion moves away from the optical axis and becomes flush with the second protruding portion.

4. The mount according to claim 2, wherein at least one of the first protruding portion or the second protruding portion protrudes beyond an outer edge of the mount body in the initial state.

5. The mount of claim 4, wherein at least one of the first protruding portion or the second protruding portion is closer to the optical axis than the fixed protruding portion in the initial state.

6. The mount according to claim 2, wherein after the movable protruding portion is disengaged from a triggered state relative to the mount body, the first protruding portion moves toward the optical axis.

7. The mount according to claim 2, wherein a length of the first protruding portion in a circumferential direction is equal to a length of the second protruding portion in the circumferential direction.

8. The mount according to claim 2, wherein the movable protruding portion further comprises a rotating portion connected to the first protruding portion and the second protruding portion, the rotating portion being rotatably connected to the mount body such that the first protruding portion and the second protruding portion are configured to swing about the rotating portion.

9. The mount according to claim 8, wherein the rotating portion is located at an intermediate position between the first protruding portion and the second protruding portion.

10. The mount according to claim 9, wherein, during engagement with the camera body, the first protruding portion swings about the rotating portion in a direction away from the optical axis, and the second protruding portion swings about the rotating portion in a direction toward the optical axis.

11. The mount according to claim 8, wherein the movable protruding portion further comprises a pressing portion configured to contact the camera body and drive the movable protruding portion to move away from the optical axis, the pressing portion being connected to the second protruding portion.

12. The mount according to claim 11, wherein the pressing portion protrudes beyond an outer edge of the mount body in the initial state.

13. The mount according to claim 12, wherein the pressing portion is connected to a side of the second protruding portion facing away from the camera body.

14. The mount according to claim 1, further comprising a restoring member connected to the mount body and the movable protruding portion, the restoring member being configured to restore the movable protruding portion.

15. The mount according to claim 14, wherein one end of the restoring member abuts against the movable protruding portion and is compressed when the movable protruding portion is engaged with the camera body, such that the restoring member stores elastic energy.

16. The mount according to claim 15, wherein the restoring member is an elastic plate attached to the mount body, and one end of the elastic plate abuts against a side of the first protruding portion facing away from the optical axis, or abuts against a side of the second protruding portion facing toward the optical axis.

17. The mount according to claim 1, wherein an angle formed between lines connecting both ends of the fixed protruding portion in a length direction and the optical axis is equal to an angle formed between lines connecting both ends of the movable protruding portion in the length direction and the optical axis in at least one of an initial state or a swung state.

18. The mount according to claim 1, wherein an angle formed between lines connecting both ends of the fixed protruding portion in a length direction and the optical axis is greater than or equal to 42°, and an angle formed between lines connecting both ends of the movable protruding portion in the length direction and the optical axis is greater than or equal to 42°.

19. The mount according to claim 1, wherein the movable protruding portion comprises a limiting protrusion configured to contact the mount body so as to limit a range of movement of the movable protruding portion.

20. An adapter ring, comprising an adapter ring body and the mount according to claim 1, wherein the mount is connected to the adapter ring body.

21. A lens, comprising a lens body and the mount according to claim 1, wherein the mount is connected to the lens body.

22. An image capturing device, comprising a camera body having a camera mount and the lens according to claim 21, wherein the lens is connected to the camera mount of the camera body through the mount.
